(19) United States
(12) Patent Application Publication
(10) Pub. No.: US 2020/0176968 A1
(43) Pub. Date: Jun. 4, 2020

(54) POWER DISTRIBUTION UNIT WITH AGGREGATE CURRENT CONTROL

(71) Applicant: Trippe Manufacturing Company, Chicago, IL (US)

(72) Inventors: Salim Ling, Bannockburn, IL (US); Miki Mauriciu Wechsler, Ness Ziona (IL); Richard Steegmueller, Morton Grove, IL (US); Ali M. Rizavi, Oak Brook, IL (US); Joseph Robert Dunne, Bolingbrook, IL (US); Shlomo Bergman, Modi'in (IL)

(21) Appl. No.: 16/436,593

(22) Filed: Jun. 10, 2019

Related U.S. Application Data
(60) Provisional application No. 62/775,273, filed on Dec. 4, 2018.

(51) Int. Cl. H02H 3/033; H02H 3/093; H02H 3/02

(52) U.S. Cl. CPC H02H 3/033; H02H 1/0007; H02H 3/025; H02H 3/093

(57) ABSTRACT

Systems and methods are provided for a power distribution device having a power input and a plurality of power receptacles. The power receptacles are coupled in parallel with each other. A switching circuit is coupled between the power input and the power receptacles. A circuit breaker detects when an aggregate current load of the receptacles is greater than a rating of the circuit breaker. The circuit breaker disconnects the power input from all of the receptacles after a first amount of time following the detection. An electronic controller is configured to disconnect a subset of the receptacles from the power input with the switching circuit to reduce the aggregate current load below the rating of the circuit breaker within a second amount of time following the detection. The second amount of time is less than the first amount of time.

### RELATED APPLICATIONS

This application claims priority to and claims the benefit of U.S. Provisional Patent Application Ser. No. 62/775,273, filed on Dec. 4, 2018, which is incorporated by reference herein in its entirety.

### BACKGROUND

Power distribution units designed for various phases, voltages, and frequencies are used in many electrical applications such as the distribution of power to servers in a data center. Power distribution unit constructions usually include a multitude of output receptacles. Per regulatory requirements, every output receptacle has to be “protected” from conducting current that exceeds its current rating. The protection is generally provided by a suitable circuit breaker arrangement upstream and separate from the power distribution unit or by output circuit breakers in the power distribution unit itself. Since the objective of the circuit breaker is to protect each output receptacle, in the common situation where a single circuit breaker is protecting multiple output receptacles, the circuit breaker's current rating has to correspond to the lowest current rated receptacle that the circuit breaker is meant to protect. As a first example, if a circuit breaker is protecting a bank of 15 Amp receptacles, then the circuit breaker has to be rated at 15 Amps. As a second example, if a circuit breaker is protecting a bank of 15 Amp and 20 Amp rated receptacles, then the circuit breaker has to be rated at 15 Amps.

A circuit breaker will trip when it carries a current that is larger than the circuit breaker's current rating. Since all the output receptacles are wired in parallel in a circuit breaker protected receptacle bank, the circuit breaker will trip when the aggregate current from all the receptacles in the bank exceeds the current rating of the circuit breaker. For example, if a 15 Amp rated circuit breaker is protecting eight receptacles that are each rated at 15 Amps, the circuit breaker will trip when the sum of all the current going through the eight receptacles exceeds 15 Amps. This can occur, for example, when one or more of the eight receptacles is carrying a current higher than the receptacle's current rating of 15 Amps, or can occur when the sum of all the currents going through all the receptacles exceeds 15 Amps while none of the receptacles carries a current exceeding its own 15 Amp current rating.

When a circuit breaker trips, power is cut off from all the receptacles in the bank, dropping all connected electrical loads in the bank. As to how soon the circuit breaker trips after the overcurrent situation starts depends on the design of the circuit breaker and the amount of overcurrent present. It can range from a few milliseconds to multiple seconds. In general, the higher the overcurrent, the sooner the circuit breaker trips. A power distribution unit that upon detecting an aggregate current that is larger than the breaker rating, reduces the aggregate current by disconnecting one or more selective loads fast enough to prevent the circuit breaker from tripping and disrupting the power to all the receptacles in a circuit breaker protected bank is needed.

### SUMMARY

This disclosure provides a power distribution unit in which a plurality of receptacles in a circuit breaker protected bank are controlled by relays. The electrical circuitry of the power distribution unit is configured to detect an overcurrent situation at a circuit breaker in real time. Once a circuit breaker overcurrent situation is detected, the power distribution unit (through, for example, a set of fixed or programmable logic) selectively turns off one or more receptacles in the bank by opening one or more corresponding relays, thus bringing the aggregate current in the bank to below the circuit breaker's current rating, all before the circuit breaker has a chance to trip. Through this operation, some of the receptacles in the bank can continue to be powered.

One benefit of the disclosure is to minimize downtime of the powered loads. In a traditional arrangement, when a circuit breaker trips, all the loads in that receptacle bank are dropped. With the power distribution units provided herein, some of the receptacles/loads that contribute to the overcurrent at the circuit breaker are turned off before the circuit breaker trips, thus keeping the other receptacles/loads in the bank powered. The power distribution units provided herein perform this operation fast enough for most of the circuit breaker overcurrent conditions that occur in the field. For example, if loads are associated with computer servers, then the power distribution units provided herein enhance server uptimes wherever the power distribution units provided herein are deployed.

The disclosure also provides a power distribution unit that monitors aggregate current across a plurality of parallel-connected current channels (for example, receptacles), and selectively disconnects individual current channels to keep the aggregate current below a rating threshold. The current at each current channel and the aggregate current across all the current channels are measured. The current supplied to each current channel is controlled by a relay. The power distribution unit includes a circuit breaker that trips and cuts power to all the current channels in a bank when the aggregate current of the bank is above the rating threshold. The disclosure includes measurement and logic circuits that allow one or more current channels of a bank to be disconnected so as to reduce the aggregate current fast enough to prevent the circuit breaker from tripping and cutting power to all the current channels in the bank.

In some embodiments, a power distribution device comprises a power input and a plurality of power receptacles including at least three power receptacles. The plurality of power receptacles are coupled in parallel with each other. A switching circuit is coupled between the power input and the plurality of power receptacles. A circuit breaker is configured to detect when an aggregate current load of the plurality of power receptacles is greater than a predetermined rating of the circuit breaker. The circuit breaker is further configured to disconnect the power input from all of the plurality of power receptacles after at least a first amount of time following the detection. An electronic controller is configured to disconnect a subset of the plurality of power receptacles from the power input with the switching circuit to reduce the aggregate current load below the predetermined rating. The electronic controller is further configured to disconnect the subset of the plurality of power receptacles within a second amount of time following the detection, which is less than the first amount of time. The subset of the plurality of power receptacles includes at least one of the plurality of power receptacles and less than all of the plurality of power receptacles.

In some embodiments, a power distribution device comprises a power input and a plurality of power receptacles including at least three power receptacles. The plurality of power receptacles are coupled in parallel with each other. A switching circuit is coupled between the power input and the plurality of power receptacles. An electronic controller is configured to (1) determine an aggregate current load of the plurality of power receptacles, (2) determine individual current loads of each of the plurality of power receptacles, and (3) disconnect a subset of the plurality of power receptacles from the power input with the switching circuit based on the individual current loads when the aggregate current load is greater than a predetermined rating to reduce the aggregate current load below the predetermined rating. The subset of the plurality of power receptacles includes at least one of the plurality of power receptacles and less than all of the plurality of power receptacles.

In some embodiments, a method for power distribution comprises detecting, by a circuit breaker connected to a power input, when an aggregate current load of a plurality of power receptacles is greater than a predetermined rating of the circuit breaker. The plurality of power receptacles includes at least three power receptacles. The plurality of power receptacles are coupled in parallel with each other. The circuit breaker is configured to disconnect the power input from the plurality of power receptacles after at least a first amount of time following the detection. An electronic controller is configured by an electronic processor executing a program stored in a memory of the electronic controller. The electronic processor is configured to disconnect a subset of the plurality of power receptacles from the power input using a switching circuit, which is coupled between the power input and the plurality of power receptacles, to reduce the aggregate current load below the predetermined rating. The disconnecting of the subset of the plurality of power receptacles occurs within a second amount of time following the detection. The second amount of time following the detection is less than the first amount of time following the detection. The subset of the plurality of power receptacles includes at least one of the plurality of power receptacles and less than all of the plurality of power receptacles.

### BRIEF DESCRIPTION OF THE DRAWINGS

FIG. 1 is a block diagram of a power distribution unit including an electronic controller, in accordance with some embodiments.

FIG. 2 is a block diagram of an electronic controller, in accordance with some embodiments.

FIG. 3 is a block diagram of a configuration of a power distribution unit, in accordance with some embodiments.

FIG. 4 is a block diagram of a power distribution unit including multiple electronic controllers, in accordance with some embodiments.

FIG. 5 is a flowchart 500 illustrating a method for disconnecting a subset of receptacles connected to a circuit breaker in a power distribution device before the circuit breaker trips and disconnects all of the receptacles connected to the circuit breaker, in accordance with some embodiments.

### DETAILED DESCRIPTION

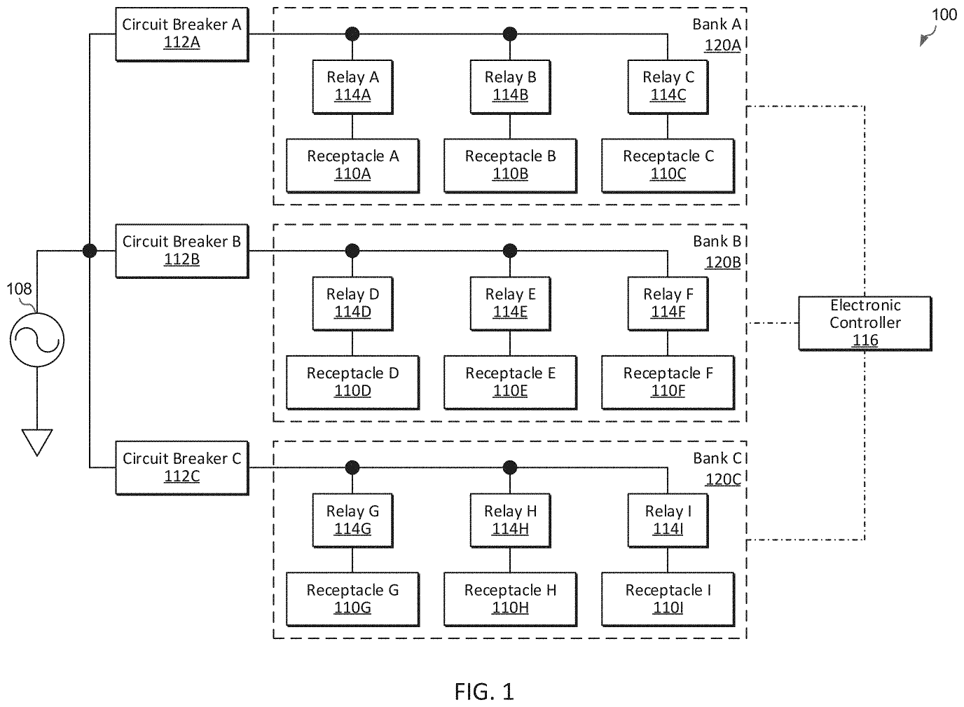

In a power distribution unit (for example, a power strip), there are multiple receptacles. The receptacles can all be in a single bank or can be grouped into multiple banks. FIG. 1 is a block diagram of one exemplary embodiment of a power distribution unit 100 that includes a power input 108, a plurality of receptacles 110, for example, the receptacles 110A-110I. The receptacles 110 may be grouped into multiple banks 120, for example, the banks 120A-120C. In alternative embodiments, the plurality of receptacles 110 are contained within a single bank 120. All the receptacles 110 within a bank 120 are wired in parallel. For example, in FIG. 1, receptacles 110A-110C in the bank 120A are wired in parallel. The power distribution unit 100 is a device and may be referred to as a power distribution device.

Per regulatory requirements, each of the banks 120 of receptacles 110 may require protection by a respective circuit breaker 112 such as the circuit breakers 112A-112C shown in FIG. 1. One goal of a circuit breaker 112 is to protect the receptacles in the bank corresponding to that circuit breaker so that none of the receptacles in that bank will exceed its individual current rating. To that end, the circuit breaker is sized to the current rating of the receptacle with the lowest current rating in the bank. As a first example, the receptacles 110A, 110B, and 110C in bank 120A are rated at 15 Amps, 20 Amps, and 20 Amps, receptively, and thus circuit breaker 112A is sized at 15 Amps. As a second example, receptacles 110D, 110E, and 110F in bank 120B are all rated at 20 Amps, and thus circuit breaker 112B is sized at 20 Amps.

A circuit breaker trips when the aggregate current for all the receptacles in the corresponding bank exceed the circuit breaker's rating/size. As a first example, the circuit breaker 112A trips when the aggregate current for the receptacles 110A, 110B, and 110C in the bank 120A exceeds 15 Amps. As a second example, the circuit breaker 112B trips when the aggregate current for the receptacles 110D, 110E, and 110F in the bank 120B exceeds 20 Amps. When a circuit breaker trips, power is cut for all the receptacles in the bank since they are all wired in parallel. For example, in FIG. 1, when circuit breaker 112C trips, power is cut from all the receptacles in the bank 120C (i.e., power is cut from receptacles 110G, 110H, and 110I).

Since the tripping of a circuit breaker is triggered by the aggregate current of all the receptacles in a bank, a breaker trips even when none of the receptacles has exceeded their individual current rating. For example, if the receptacles 110A, 110B, and 110C are drawing 10 Amps, 7 Amps, and 1 Amp, respectively (for an aggregate current of 18 Amps), the circuit breaker 112A (sized at 15 Amps) trips even though none of the receptacles 110A-110C have exceeded their individual current rating.

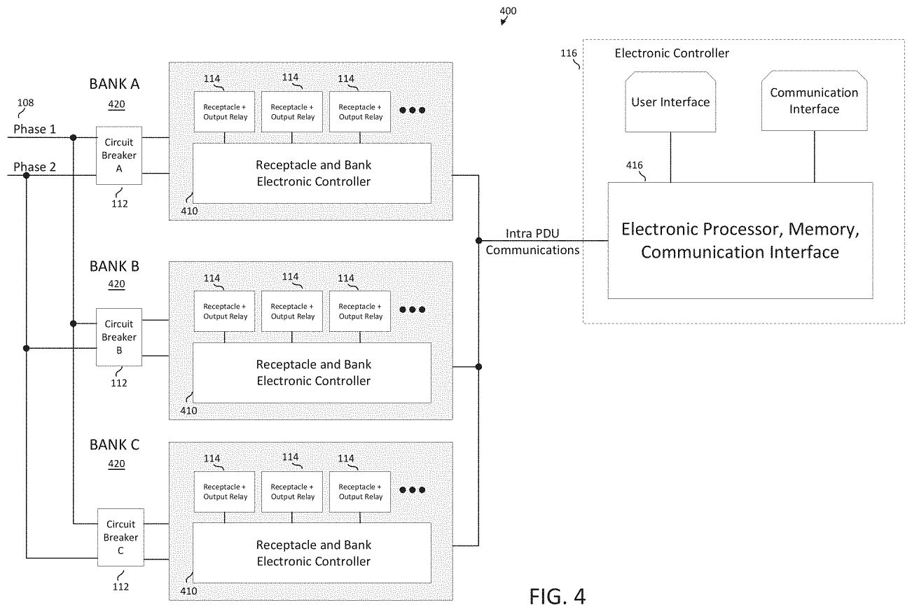

In FIG. 1, the power supplied to each receptacle 110 is controlled by a relay 114, for example the relays 114A-114I. A relay 114 may be referred to as a switching circuit 114. For example, the current applied to the receptacle 110A is controlled by relay 114A and the current applied to the receptacle 110B is controlled by relay 114B. The relays 110 are individually controlled by an electronic controller 116. For example, the electronic controller 116 is configured to send signals that cause the relays 114 to turn on and off Although the power distribution unit 100 of FIG. 1 includes the relays 114, any suitable type of switching circuit 114 may be utilized. For example, a solid-state device such as a semiconductor controlled rectifier (SCR) or a triac may be used as a switching circuit 114 in the power distribution unit 100 or the power distribution unit 400 shown in FIG. 4.

The electronic controller 116 detects (in real-time) the current at each receptacle 110 and the aggregate current in each of the banks 120. In some embodiments, a current sensor is connected to the supply line of each receptacle 110, and the electronic controller 116 determines the current at a receptacle 110 based on measurements from the current sensor connected to the supply line of the receptacle 110. In some embodiments, the electronic controller 116 determines the aggregate current in a particular bank 120 by adding the currents measured by the current sensors connected to the supply lines of the receptacles of the particular bank 120. Alternatively or in addition, the electronic controller 116 determines the aggregate current in a particular bank 120 based on measurements from a current sensor that measures the current at a master supply line for the particular bank 120.

A circuit breaker is configured (or designed) to trip when the aggregate current exceeds a rating of the circuit breaker for a predetermined period of time (i.e., a trip time). The predetermined period of time may be configurable by a user or may be pre-configured during manufacturing. For example, the circuit breaker 112C may be configured (or designed) to trip when the aggregate current in bank 120C exceeds 20 Amps for 100 milliseconds. The electronic controller 116 operates the relays 114 to prevent the aggregate current in a corresponding bank 120 from exceeding the rating of the corresponding circuit breaker 112 for a period a time longer than the trip time of the circuit breaker 112. For example, when the electronic controller 116 detects the aggregate current in the bank 120B has exceeded the rating of the circuit breaker 112B, the electronic controller selectively turns off one or more of relays 114D, 114E, and 114F in the bank 120B before the circuit breaker 112B has time to trip. The aggregate current is reduced fast enough to prevent the circuit breaker 112B from tripping and taking down the power to all the receptacles 110D-110E in that bank 120B. As a result, the power distribution unit 100 prevents unnecessary power disruptions caused when a circuit breaker 112 is tripped but the corresponding receptacles 110 are not exceeding their individual current ratings. For example, in a data center, the power distribution unit 100 increases the “up time” calculation for servers connected to the receptacles 110 in a corresponding bank 120 by preventing unnecessary current disruptions to the receptacles 110 in the corresponding bank 120 that can occur when the corresponding circuit breaker 112 of the bank trips even though one or more receptacles in the corresponding bank 120 is drawing less current than its current rating.

In some embodiments, to prevent a circuit breaker from tripping, the electronic controller 116 opens the relay to the receptacle in the bank that most recently started drawing current. For example, upon detecting that the aggregate current in the bank 120A exceeds the rating of the circuit breaker 112A, the electronic controller 116 may turn off the relay 114B if the receptacle 110B was the most recent receptacle in the bank 120A to draw current. Alternatively or in addition, the electronic controller 116 opens the relay to the receptacle in the bank that is drawing the greatest amount of current. For example, upon detecting that the aggregate current in the bank 120C exceeds the rating of the circuit breaker 112C, the electronic controller 116 may turn off relay 114I if the receptacle 110I is drawing more current than the receptacles 110G and 110H. In some embodiments, upon detecting that a receptacle in the bank has exceed its current rating, and thus the current rating of the circuit breaker, the electronic controller turns off the relay to the receptacle. For example, upon detecting that the receptacle 110A has exceeded 15 Amps, the electronic controller 116 turns off the relay 114A.

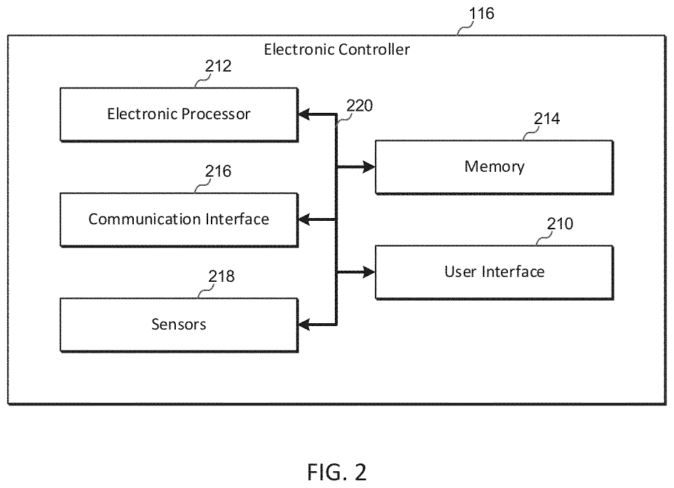

FIG. 2 is a block diagram of one example embodiment of an electronic controller. An electronic controller 116 illustrated in FIG. 2 includes an electronic processor 212 (for example, a microprocessor), memory 214, a communication interface 216, a user interface 210, sensors 218, and a bus 220. The bus 220 connects various components of the electronic controller 116, for example, the memory 214 to the electronic processor 212.

The memory 214 includes read-only memory (ROM), random access memory (RAM), electrically erasable programmable read-only memory (EEPROM), Flash memory, other non-transitory computer-readable media, or a combination thereof. The electronic processor 212 is configured to retrieve program instructions and data from the memory 214 and execute, among other things, program instructions to perform the functions described herein. For example, the memory 214 may store program instructions for operating the relays described with respect to FIG. 1.

The communication interface 216 includes routines for transferring information between components within the electronic controller 116 and other components of the power distribution unit 100, as well as components external to the power distribution unit 100. The communication interface 216 is configured to transmit and receive signals via wires, fiber, wirelessly, or a combination thereof. Signals may include, for example, information, data, serial data, data packets, analog signals, or a combination thereof.

The user interface 210 is included for control of the electronic controller 116 or the operation of the power distribution unit 100 as a whole. The user interface 210 is operably coupled to the electronic processor 212 to control, for example, the state of the relays 114. The user interface 210 displays visual output generated by software applications executed by the electronic processor 212. Some examples of visual output are graphical indicators, lights, colors, text, images, and graphical user interfaces (GUIs). The user interface 210 includes a suitable display mechanism for displaying visual output (for example, a light-emitting diode (LED) screen, a liquid crystal display (LCD) screen, or an organic LED (OLED) screen). In some embodiments, the user interface 210 includes a touch sensitive interface (for example, a touch-screen display). The touch-screen display receives user input using detected physical contact (for example, detected capacitance or resistance). Based on the user input, the touch-screen display outputs signals to the electronic processor 212 that indicate positions on the touch-screen display currently being selected by physical contact. Alternatively or in addition, the user interface 210 receives user input from input devices, for example, knobs, dials, switches, buttons, and keypads.

The sensors 218 include, among other things, current sensors that detect electric current in a wire, and generate signals proportional to the detected current. The sensors 218 may be located on the electronic controller 116 or near supply wires to the receptacles 110, for example. The generated signals may be analog voltages, analog currents, digital outputs, and the like. Some examples of current sensors 218 are Hall effect integrated circuit (IC) sensors, current clamp meters, fluxgate transformer type sensors, fiber optic current sensors, Rogowski coils, shunt resistors, solid state measurement ICs, and current transformers.

The embodiment of the power distribution unit 100 illustrated in FIG. 1 includes one electronic controller 116. In alternate embodiments, the power distribution unit 100 includes more than one electronic controller. For example, each bank 120 in the power distribution unit 100 may include one or more electronic controllers. In some embodiments, the power distribution unit 100 includes a master electronic controller and each bank includes one or more slave electronic controllers (see FIG. 4)

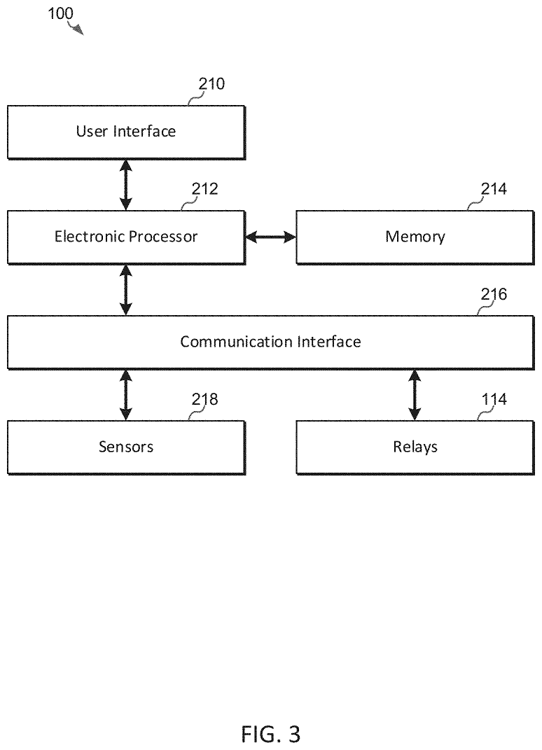

FIG. 3 is a block diagram of one exemplary embodiment of a power distribution unit.

The power distribution unit 100 illustrated in FIG. 3 includes the user interface 210, the electronic processor 212, the memory 214, the communication interface 216, the sensors 218, and the relays 114.

As noted above, the electronic processor 212 is configured to retrieve program instructions and data from the memory 214 and execute, among other things, program instructions to perform the functions described herein. For example, the memory 214 may store program instructions for operating the relays 114 based on information received from the sensors 218. The electronic processor may communicate via the communication interface 216 with the sensors 218 and the relays 114.

FIG. 4 is a block diagram of one exemplary embodiment of a power distribution unit including multiple electronic controllers. The power distribution unit 400 illustrated in FIG. 4 includes a master electronic controller 416 and three banks 420. Each of the three banks 420 includes, among other things, a plurality of receptacle and output relay boards 114, and a receptacle and bank electronic controller unit (CPU) board 410 (i.e., electronic controller). Each of the receptacle and output relay boards 114 includes, among other things, a relay (i.e., switching circuit) coupled to a corresponding receptacle. Each receptacle and bank electronic controller board 410 includes, among other things, an electronic controller. The electronic controller of a particular bank 420 is configured to detect the current transmitted to each receptacle and output relay 114 within the particular bank, the aggregate current of the particular bank, or both. Because a particular receptacle and bank electronic controller 410 of a particular bank 420 is positioned closer to the receptacles and the relays 114 within the particular bank than the master electronic controller 416, the particular receptacle and bank electronic controller 410 detects the currents in the particular bank 420 faster than the master electronic controller 416. This faster current detection enables the power distribution unit 400 to reduce the aggregate current faster by opening relays, thereby preventing unnecessary current disruptions that can occur when a circuit breaker 112 trips. The power distribution unit 400 is a device may be referred to as a power distribution device.

In some embodiments, each bank 420 in the power distribution unit 400 includes more than one processing element within a receptacle and bank electronic controller 410. For example, a particular bank 420 in the power distribution unit 400 may include fourteen receptacles 110, fourteen relays 114, and two processing elements within a receptacle and bank electronic controller 410. One processing unit within the receptacle and bank electronic controller 410 may control eight of the receptacles 110 in the particular bank 420, and the other processing unit within the receptacle and bank electronic controller 410 may control six receptacles 110 in the particular bank 420.

In some embodiments, a power distribution unit 100 or 400 comprises a power input 108, a plurality of power receptacles 110 including at least three power receptacles 110 that are coupled in parallel with each other. A switching circuit 114 is coupled between the power input 108 and the plurality of power receptacles 114. A circuit breaker 112 is configured to detect when an aggregate current load of the plurality of power receptacles 110 is greater than a predetermined rating of the circuit breaker 112, where the circuit breaker 112 is also configured to disconnect the power input 108 from all of the plurality of power receptacles 112 after at least a first amount of time following the detection. An electronic controller 116 or 410 is configured to disconnect a subset of the plurality of power receptacles 110 from the power input 108 with the switching circuit 114 to reduce the aggregate current load below the predetermined rating. The electronic controller 116 or 410 is also configured to disconnect the subset of the plurality of power receptacles 110 within a second amount of time following the detection that is less than the first amount of time, where the subset of the plurality of power receptacles 110 includes at least one of the plurality of power receptacle 110 and less than all of the plurality of power receptacles 110.

In some embodiments, a power distribution unit 100 or 400 comprises a power input 108, a plurality of power receptacles 110 including at least three power receptacles 110. The plurality of power receptacles are coupled in parallel with each other. A switching circuit 114 is coupled between the power input 108 and the plurality of power receptacles 110. An electronic controller 116 or 410 is configured to (1) determine an aggregate current load of the plurality of power receptacles 110, (2) determine individual current loads of each of the plurality of power receptacles 110, and (3) disconnect a subset of the plurality of power receptacles 110 from the power input 108 with the switching circuit 114 based on the individual current loads when the aggregate current load is greater than a predetermined rating to reduce the aggregate current load below the predetermined rating. The subset of the plurality of power receptacles 110 includes at least one of the plurality of power receptacles 110 and less than all of the plurality of power receptacles 110.

In the power distribution unit 100 or 400, the electronic controller 116 or 410 also may be configured to determine individual current loads of each of the plurality of power receptacles 110, rank each of the plurality of power receptacles 110 based on the individual current loads to determine a ranking order, and select the subset of the plurality of power receptacles 110 based on the ranking order. For example, the electronic controller 116 or 410 may be configured to rank each of the plurality of power receptacles 110 in order from the power receptacle 110 with the greatest individual current load to the power receptacle 110 with the least individual current load, and/or in order from the power receptacle 110 with a most recent increase in the individual current load to the power receptacle 110 with a least recent increase in the individual current load. Alternatively or in addition, the electronic controller 116 or 410 may be configured to rank each of the plurality of power receptacles 110 based on user input via the user interface 210 to determine a ranking order, and to select the subset of the plurality of power receptacles 110 based on the ranking order.

In the power distribution unit 100 or 400 the electronic controller 116 or 410 may be configured to receive an external control signal via the communication interface 216 when the subset of the plurality of power receptacles 110 is disconnected from the power input 108, and reconnect the subset of the plurality of power receptacles 110 to the power input in response to receiving the external control signal via the communication interface 216.

In the power distribution unit 100 or 400 the electronic controller 116 or 410 may be configured to (1) determine a first measurement of the aggregate current load responsive to the detection of the aggregate current load being higher than the predetermined rating of the circuit breaker 112, (2) determine a first trip time for the circuit breaker 112 based at least in part on the first measurement of the aggregate current load, (3) disconnect the subset of the plurality of power receptacles 110 from the power input 108 within the second amount of time when the first trip time is less than a time threshold, (4) determine a second measurement of the aggregate current load when the first trip time is greater than or equal to the time threshold, (5) determine a second trip time for the circuit breaker based at least in part on the second measurement of the aggregate current load, and (6) disconnect the subset of the plurality of power receptacles 110 from the power input 108 within the second amount of time when the second trip time is less than the time threshold. In the power distribution unit 100 or 400, the switching circuit 114 includes at least one type of switching device selected from a group consisting of relays and solid-state devices.

In the power distribution unit 100 or 400, the electronic controller 116 or 410 may be configured to (1) determine a first measurement of the aggregate current load responsive to the aggregate current load being higher than the predetermined rating, (2) determine a first trip time based at least in part on the first measurement of the aggregate current load, (3) disconnect the subset of the plurality of power receptacles 110 from the power input 108 based on the individual current loads when the first trip time is less than a time threshold, (4) determine a second measurement of the aggregate current load when the first trip time is greater than or equal to the time threshold, (5) determine a second trip time based at least in part on the second measurement of the aggregate current load, and (6) disconnect the subset of the plurality of power receptacles 110 from the power input 108 when the second trip time is less than the time threshold. Steps (4) and (5) above may occur one or more additional times before reaching step 6. For example, after step (5) a third measurement of the aggregate current load may be determined when the second trip time is greater than or equal to the time threshold, and a third trip time may be determined based at least in part on the third measurement of the aggregate current load.

In some embodiments, a method for power distribution comprises detecting, by the circuit breaker 112 connected to the power input 108, when an aggregate current load of a plurality of power receptacles 110 is greater than a predetermined rating of the circuit breaker 112. The plurality of power receptacles 110 includes at least three power receptacles 110. The plurality of power receptacles 110 are coupled in parallel with each other. The circuit breaker 112 is configured to disconnect the power input from the plurality of power receptacles 110 after at least a first amount of time following the detection. An electronic controller 116 or 410 is configured by an electronic processor 212 executing a program stored in a memory 214 of the electronic controller 116 or 410 to disconnect a subset of the plurality of power receptacles 110 from the power input 108 using a switching circuit 114 coupled between the power input 108 and the plurality of power receptacles 110 to reduce the aggregate current load below the predetermined rating. The disconnecting of the subset of the plurality of power receptacles 110 occurs within a second amount of time following the detection. The second amount of time following the detection is less than the first amount of time following the detection. The subset of the plurality of power receptacles 110 includes at least one of the plurality of power receptacles 110 and less than all of the plurality of power receptacles 110.

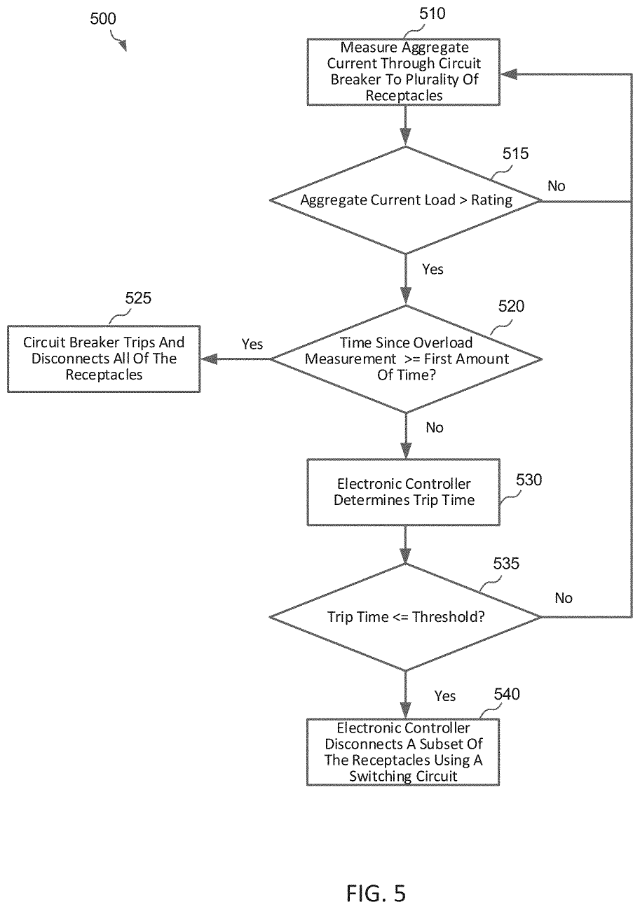

FIG. 5 is a flowchart 500 illustrating a method for disconnecting a subset of receptacles connected to a circuit breaker in a power distribution unit before the circuit breaker trips and disconnects all of the receptacles connected to the circuit breaker.

In step 510, a circuit breaker 112 that is connected to a power input 108 measures an aggregate current load of a plurality of power receptacles 110. The plurality of power receptacles 110 are each coupled in parallel with each other. A switching circuit 114 is coupled between the power input 108 and the plurality of power receptacles 110.

In step 515, in instances when the circuit breaker 112 detects that the aggregate current load of the plurality of power receptacles 110 is greater than a predetermined load rating of the circuit breaker 112, the method proceeds to step 520.

In step 520, in instances when an amount of time following the measurement of the over ratings load is after a first amount of time, the method proceeds to step 525. In step 525, the circuit breaker 112 disconnects the power input 108 from all of the plurality of power receptacles 110.

In step 520, in instances when the amount of time following the measurement of the over ratings load is not after the first amount of time, the method proceeds to 530. In step 530, the electronic controller 116 or 410 determines a trip time that is based on an amount until the circuit breaker 112 will trip due to the measured over ratings load.

In step 535, in instances when the trip time is less than or equal to a time threshold, the method proceeds to step 540. In step 540, the electronic controller 116 or 410 disconnects a subset of the plurality of power receptacles 110 from the power input 108 using a switching circuit 114 coupled between the power input 108 and the plurality of power receptacles 110 to reduce the aggregate current load below the predetermined rating.

In step 535, in instances when the trip time is not less than or equal to the time threshold, the method proceeds to step 510.

It is to be understood that the power distribution unit 100 or 400 is not limited in its application to the details of construction and the arrangement of components set forth in the detailed description herein or illustrated in the accompanying drawings. The power distribution unit is capable of other embodiments and of being practiced or of being carried out in various ways.

It should also be noted that a plurality of different structural components may be utilized to implement the disclosure. Furthermore, and as described in the preceding paragraphs, the specific configurations illustrated in the drawings are intended to exemplify embodiments of the disclosure. Alternative configurations are possible.

We claim:

1. A power distribution device, comprising
a power input;
a plurality of power receptacles including at least three power receptacles and coupled in parallel with each other;
a switching circuit coupled between the power input and the plurality of power receptacles;
a circuit breaker configured to detect when an aggregate current load of the plurality of power receptacles is greater than a predetermined rating of the circuit breaker, wherein the circuit breaker is further configured to disconnect the power input from all of the plurality of power receptacles after at least a first amount of time following the detection; and
an electronic controller configured to disconnect a subset of the plurality of power receptacles from the power input with the switching circuit to reduce the aggregate current load below the predetermined rating, wherein the electronic controller is further configured to disconnect the subset of the plurality of power receptacles within a second amount of time following the detection that is less than the first amount of time, wherein the subset of the plurality of power receptacles includes at least one of the plurality of power receptacles and less than all of the plurality of power receptacles.

2. The power distribution device of claim 1, wherein the electronic controller is further configured to
determine individual current loads of each of the plurality of power receptacles,
rank each of the plurality of power receptacles based on characteristics of the individual current loads to determine a ranking order, and
select the subset of the plurality of power receptacles based on the ranking order.

3. The power distribution device of claim 2, wherein the electronic controller is further configured to rank each of the plurality of power receptacles in order from the power receptacle with the greatest individual current load to the power receptacle with the least individual current load.

4. The power distribution device of claim 2, wherein the electronic controller is further configured to rank each of the plurality of power receptacles in order from the power receptacle with a most recent increase in the individual current load to the power receptacle with a least recent increase in the individual current load.

5. The power distribution device of claim 1, wherein the electronic controller is further configured to
rank each of the plurality of power receptacles based on user input to determine a ranking order, and
select the subset of the plurality of power receptacles based on the ranking order.

6. The power distribution device of claim 1, wherein the electronic controller is further configured to
receive an external control signal when the subset of the plurality of power receptacles is disconnected from the power input, and
reconnect the subset of the plurality of power receptacles to the power input in response to receiving the external control signal.

7. The power distribution device of claim 1, wherein the electronic controller is further configured to
determine a first measurement of the aggregate current load responsive to the detection of the aggregate current load being higher than the predetermined rating of the circuit breaker,
determine a first trip time for the circuit breaker based at least in part on the first measurement of the aggregate current load,
disconnect the subset of the plurality of power receptacles from the power input within the second amount of time when the first trip time is less than a time threshold,
determine a second measurement of the aggregate current load when the first trip time is greater than or equal to the time threshold,
determine a second trip time for the circuit breaker based at least in part on the second measurement of the aggregate current load, and
disconnect the subset of the plurality of power receptacles from the power input within the second amount of time when the second trip time is less than the time threshold.

8. The power distribution device of claim 1, wherein the switching circuit includes at least one type of switching device selected from a group consisting of relays and solid-state devices.

9. A power distribution device, comprising
a power input;
a plurality of power receptacles including at least three power receptacles and coupled in parallel with each other;
a switching circuit coupled between the power input and the plurality of power receptacles; and
an electronic controller configured to
determine an aggregate current load of the plurality of power receptacles,
determine individual current loads of each of the plurality of power receptacles, and
disconnect a subset of the plurality of power receptacles from the power input with the switching circuit based on characteristics of the individual current loads when the aggregate current load is greater than a predetermined rating to reduce the aggregate current load below the predetermined rating, wherein the subset of the plurality of power receptacles includes at least one of the plurality of power receptacles and less than all of the plurality of power receptacles.

10. The power distribution device of claim 9, wherein the electronic controller is further configured to
rank each of the plurality of power receptacles based on the individual current loads to determine a ranking order, and
select the subset of the plurality of power receptacles based on the ranking order.

11. The power distribution device of claim 10, wherein the electronic controller is further configured to rank each of the plurality of power receptacles in order from the power receptacle with the greatest individual current load to the power receptacle with the least individual current load.

12. The power distribution device of claim 10, wherein the electronic controller is further configured to rank each of the plurality of power receptacles in order from the power receptacle with a most recent increase in the individual current load to the power receptacle with a least recent increase in the individual current load.

13. The power distribution device of claim 9, wherein the electronic controller is further configured to
rank each of the plurality of power receptacles based on user input to determine a ranking order, and
further select the subset of the plurality of power receptacles based on the ranking order.

14. The power distribution device of claim 9, wherein the electronic controller is further configured to
receive an external control signal when the subset of the plurality of power receptacles is disconnected from the power input, and
reconnect the subset of the plurality of power receptacles to the power input in response to receiving the external control signal.

15. The power distribution device of claim 9, wherein the electronic controller is further configured to
determine a first measurement of the aggregate current load responsive to the aggregate current load being higher than the predetermined rating,
determine a first trip time based at least in part on the first measurement of the aggregate current load,
disconnect the subset of the plurality of power receptacles from the power input based on characteristics of the individual current loads when the first trip time is less than a time threshold,
determine a second measurement of the aggregate current load when the first trip time is greater than or equal to the time threshold,
determine a second trip time based at least in part on the second measurement of the aggregate current load, and
disconnect the subset of the plurality of power receptacles from the power input when the second trip time is less than the time threshold.

16. The power distribution device of claim 9, wherein the switching circuit includes at least one type of switching device selected from a group consisting of relays and solid-state devices.

17. A method for power distribution, the method comprising
detecting, by a circuit breaker connected to a power input, when an aggregate current load of a plurality of power receptacles is greater than a predetermined rating of the circuit breaker, wherein
the plurality of power receptacles includes at least three power receptacles;
the plurality of power receptacles are coupled in parallel with each other; and
the circuit breaker is configured to disconnect the power input from the plurality of power receptacles after at least a first amount of time following the detection; and
disconnecting, by an electronic controller configured by an electronic processor executing a program stored in a memory of the electronic controller, a subset of the plurality of power receptacles from the power input using a switching circuit coupled between the power input and the plurality of power receptacles to reduce the aggregate current load below the predetermined rating, wherein
the disconnecting of the subset of the plurality of power receptacles occurs within a second amount of time following the detection, the second amount of time following the detection is less than the first amount of time following the detection, and
the subset of the plurality of power receptacles includes at least one of the plurality of power receptacles and less than all of the plurality of power receptacles.

18. The method of claim 17 further comprising:
determining individual current loads of each of the plurality of power receptacles,
ranking each of the plurality of power receptacles based on the individual current loads to determine a ranking order, and
selecting the subset of the plurality of power receptacles based on the ranking order, wherein
each of the plurality of power receptacles is ranked in order from the power receptacle with the greatest individual current load to the power receptacle with the least individual current load, or
each of the plurality of power receptacles is ranked in order from the power receptacle with a most recent increase in the individual current load to the power receptacle with a least recent increase in the individual current load.

19. The method of claim 17 further comprising:
receiving an external control signal when the subset of the plurality of power receptacles is disconnected from the power input, and
reconnecting the subset of the plurality of power receptacles to the power input in response to receiving the external control signal.

20. The method of claim 17 further comprising:
determining a first measurement of the aggregate current load responsive to the detection of the aggregate current load being higher than the predetermined rating of the circuit breaker,
determining a first trip time for the circuit breaker based at least in part on the first measurement of the aggregate current load,
disconnecting the subset of the plurality of power receptacles from the power input within the second amount of time when the first trip time is less than a time threshold,
determining a second measurement of the aggregate current load when the first trip time is greater than or equal to the time threshold,
determining a second trip time for the circuit breaker based at least in part on the second measurement of the aggregate current load, and
disconnecting the subset of the plurality of power receptacles from the power input within the second amount of time when the second trip time is less than the time threshold.
